(19) United States
(12) Patent Application Publication
(10) Pub. No.: US 2012/0240023 A1
(43) Pub. Date: Sep. 20, 2012

(54) DISPLAY DEVICE, DISPLAY SYSTEM, AND COMPUTER PROGRAM PRODUCT

(75) Inventor: Yoshihisa Ohguro, Kanagawa (JP)

(73) Assignee: RICOH COMPANY, LIMITED, Tokyo (JP)

(21) Appl. No.: 13/414,893

(22) Filed: Mar. 8, 2012

(30) Foreign Application Priority Data
Mar. 14, 2011 (JP) 2011-055477

(51) Int. Cl. G06F 17/00; G06K 19/06

(52) U.S. Cl. 715/221; 715/273; 235/494

(57) ABSTRACT

A display device is capable of connecting to an information processing apparatus through a network, generates data for display based on electronic data of a document, and performs image display using the generated data for display. The display device includes a Web server unit that publishes Web content; a document structure analysis unit that analyzes a logical structure of the document and extracts elements of the logical structure; a data conversion unit that converts data of each of the elements extracted as an analysis result by the document structure analysis unit into Web content; and a publication processing unit that places the Web content converted by the data conversion unit on the Web server unit.

### CROSS-REFERENCE TO RELATED APPLICATIONS

The present application claims priority to and incorporates by reference the entire contents of Japanese Patent Application No. 2011-055477 filed in Japan on Mar. 14, 2011.

### BACKGROUND OF THE INVENTION

1. Field of the Invention

The present invention relates to a display device, a display system, and a computer program product.

2. Description of the Related Art

In the conventional art, to provide a viewer with a document serving as material for a lecture, a conference and the like, projectors that perform screen display based on imaging data of the material have been used.

There has been proposed a technique in which a Web server is located on a network to publish an image displayed by a projector as material for a lecture and the like (for example, see Japanese Patent Application Laid-open No. 2010-146085 and Japanese Patent Application Laid-open No. 2009-130485). Furthermore, there has been proposed a method of receiving distribution of a material image displayed using a projector and managing the material image by a Web server on a network by writing a questionnaire and the like (for example, see Japanese Patent Application Laid-open No. 2010-146085).

However, in the conventional art, the material of the lecture and the like is only published by the Web server as an image, and abundant functions as Web contents are not fully utilized. Moreover, an amount of delivery data is large in terms of an image format and processing load is large in browsers of both a Web server and a Web client. If reducing the resolution at the time of delivery, details of the material of a lecture, a conference and the like, may not be accurately reproduced.

Furthermore, the conventional examples are not assuming that a questionnaire and the like such as the collection of reaction of unspecified audience members are used. Therefore, if the conventional examples are applied to a case in which material is displayed for the unspecified audience members and a questionnaire is performed, advance preparations are necessary for each material and reaction from the unspecified audience members may not be collected for material having not passed through the advance preparations, resulting in an increase in load of a lecturer and the like who will make the advance preparations.

This is because when bi-directional communication is established between an organizer and audience members of a lecture and the like by using the Web server, it is necessary for the audience members to initially access the Web server. A Uniform Resource Locator (URL) of the Web server may be allowed to be widely known in advance. However, when a publication range is desired to be limited, such as limited publication of information only to participants of a lecture and the like, or when a URL may be changed, it is preferable for the URL to be widely known immediately before the lecture.

When a list of the participants of the lecture exists, the URL may be provided to each participant through an email and the like. However, in the case of a lecture for many unspecified audience members, since URL information is projected as an image in a conference room through a projector and the like, and the audience members read the image, enter the information on their own Web browsers and access the Web server, effort for this procedure is necessary.

Therefore, in the display device or a display system having a function capable of publishing an input document through the Web server, there is a need to reduce a processing load of a Web server and a Web client, expand functions by adding a function for establishing bi-directional communication with unspecified audience members when a display device is used for a lecture, and simply distribute document data to be published by the Web server when the above-mentioned function is used.

### SUMMARY OF THE INVENTION

According to an embodiment, there is provided a display device that is capable of connecting to an information processing apparatus through a network, generates data for display based on electronic data of a document, and performs image display using the generated data for display. The display device includes a Web server unit that publishes Web content; a document structure analysis unit that analyzes a logical structure of the document and extracts elements of the logical structure; a data conversion unit that converts data of each of the elements extracted as an analysis result by the document structure analysis unit into Web content; and a publication processing unit that places the Web content converted by the data conversion unit on the Web server unit.

According to another embodiment, there is provided a display system including a display device that generates data for display based on electronic data of a document and performs image display using the generated data for display; and a server that is connected to the display device through a network. The display device includes a Web server unit that publishes Web content; a document structure analysis unit that analyzes a logical structure of the document and extracts elements of the logical structure; and a data conversion unit that converts data of each of the elements extracted as an analysis result by the document structure analysis unit into Web content. The server includes a Web content accumulation unit that accumulates the Web content converted by the data conversion unit and transmitted from the display device through the network; and a publication processing unit that places the Web content on the Web server unit of the display device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration example of a system including a display device and an information processing apparatus;

FIG. 2 is a block diagram illustrating the configuration of a data processing system including a display device according to an embodiment;

FIG. 3 is a diagram illustrating a flow of data processing from document input process to a publication process in the data processing system of FIG. 2;

FIG. 4 is a diagram illustrating a configuration example of an OOXML document;

FIG. 5 is a diagram illustrating an example of a document for explaining a format of an OOXML document;

FIG. 6 is a diagram illustrating the XML expression of “This is the title” of FIG. 5;

FIG. 7 is a diagram illustrating the XML expression of “1. This is headline 1” of FIG. 5;

FIG. 8 is a diagram illustrating the XML expression of “This is the first sentence of paragraph 1. This is the second sentence of paragraph 1.” of FIG. 5;

FIG. 9 is a diagram illustrating a document example in which a full text of FIG. 5 is converted from an XML format to an HTML format;

FIGS. 10A and 10B are diagrams explaining a questionnaire form additionally insertable into Web content;

FIG. 11 is a diagram explaining a communication method using a two-dimensional barcode from a display device to an information terminal;

FIG. 12 is a block diagram illustrating a hardware configuration of a computer provided in a display device of a ninth embodiment;

FIG. 13 is a diagram illustrating a configuration example of a display device constructed using a network; and

FIG. 14 is a block diagram illustrating the configuration of a display system according to a tenth embodiment.

### DETAILED DESCRIPTION OF THE PREFERRED EMBODIMENTS

Hereinafter, exemplary embodiments of a display device and a display system according to the present invention will be described in detail with reference to the accompanying drawings.

A display device or a display system according to the present invention have a function of receiving the input of electronic data of a document, performing image display using display data generated based on the document, and publishing the input document through a Web server.

In a system proposed in the conventional art in which a Web server for publishing an image displayed on a display as material of a lecture and the like is provided on a network, since the Web server delivers an image to be displayed, abundant functions as Web content are not fully utilized. Moreover, since an amount of delivery data is large in terms of an image format and a processing load is large in browsers of both the Web server and a Web client. If reducing the resolution at the time of delivery, details of the material of a lecture may not be accurately reproduced.

In this regard, the display device and the display system of the embodiment have a function of analyzing the logical structure of a document input as electronic data, extracting elements of the logical structure, and automatically converting each of the extracted elements into Web content. For example, if the material of the lecture is an Office Open Extensible Markup Language (OOXML) document, since information defined as an element in an XML format is easily extractable and is automatically convertable from the XML format into Hyper Text Markup Language (HTML) treated as Web content, this processing and conversion function is used herein.

Consequently, a Web server and the processing and conversion function are provided in a display device such as a projector, and an OOXML document, which is material of the lecture, is input to the display device, whereby the material can be published.

In addition to the material displayed on a screen of a display device such as a projector, audience members of the lecture can access the Web server to see the material or download the material. Furthermore, since the material is converted into Web content and a data amount is significantly reduced as compared with the case where lecture material is published as an image, it is possible to avoid the problem that details of material are not seen due to the influence of resolution caused by a process performed when a display image is used in delivery.

Prior to explaining an embodiment of the present invention, the configuration and expression format of a document to be input to the display device of the embodiment and to be processed as Web content will be first described because, although they are existing technique, they are basic assumptions of the present invention.

Material of a lecture is electronic data, and diagrams and text portions are integrated with a logical structure, and are not imaged in units of one page. The diagram is created with resolution sufficient for understanding, and the text portion is expressed in arbitrary fonts.

If a document as the electronic data is used as the material of the lecture and can be published on a Web server without imaging the document, it may be possible to suppress an increase in the amount of delivery data and to avoid the problem in the conventional art that resolution is reduced.

In the embodiment, as an example of an electronic document format of the material of the lecture, an Office Open XML (OOXML) document advocated by Microsoft (registered trademark) Corporation will be described. However, an electronic document format is not limited to the OOXML document, and any electronic document having a logical structure may be used.

FIG. 4 is a diagram illustrating a configuration example of an OOXML document.

Conventionally, since an independent format of each company is used as an electronic data format of lecture material in many cases, it is difficult to use electronic data without a dedicated application. In order to solve the problem, the OOXML document mainly uses an XML format which is an electronic data format treated in standard technique, and archives a plurality of pieces of data configured only by using an additional standard data format through a standard compression scheme Zip.

In the configuration example of FIG. 4, elements of the OOXML document are as follows:

document.xml: text content;

fontTable.xml: font table;

settings.xml: setting information;

styles.xml: style information of text;

webSettngs.xml: style information for Web;

media: folder for storing media file such as image; and

_rels: folder for storing file describing relationship among parts.

With the above data format, it is possible to access the OOXML document through any application that supports the XML format, and to easily operate the electronic data. That is, it is possible to extract the whole or a part of data using the standard technique and to use the data for other purposes. In addition, the OOXML has been standardized as “ISO/IEC 29500.”

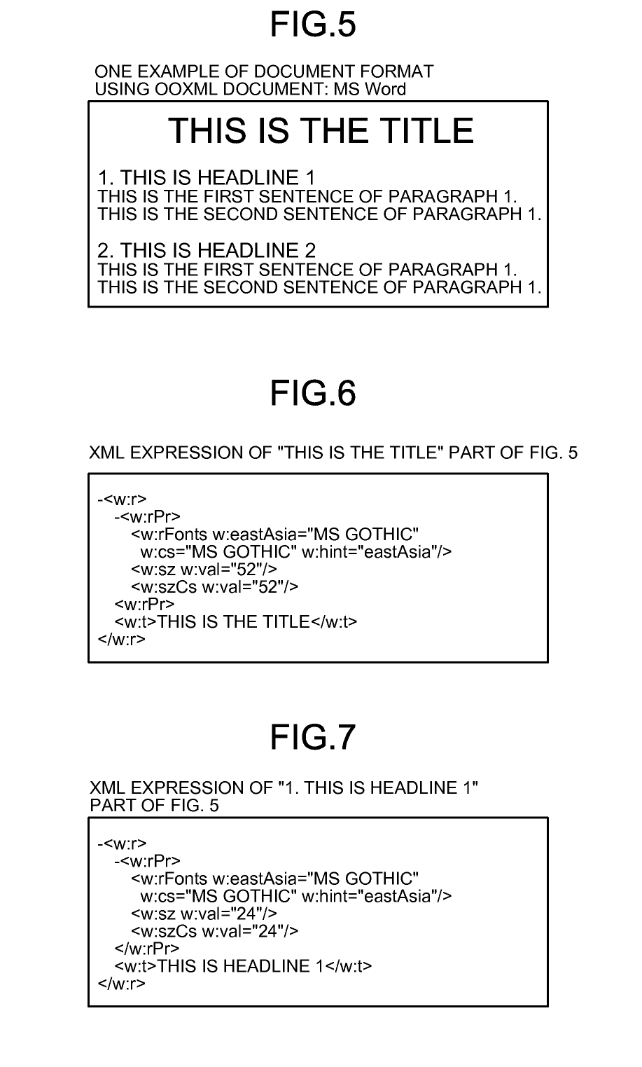

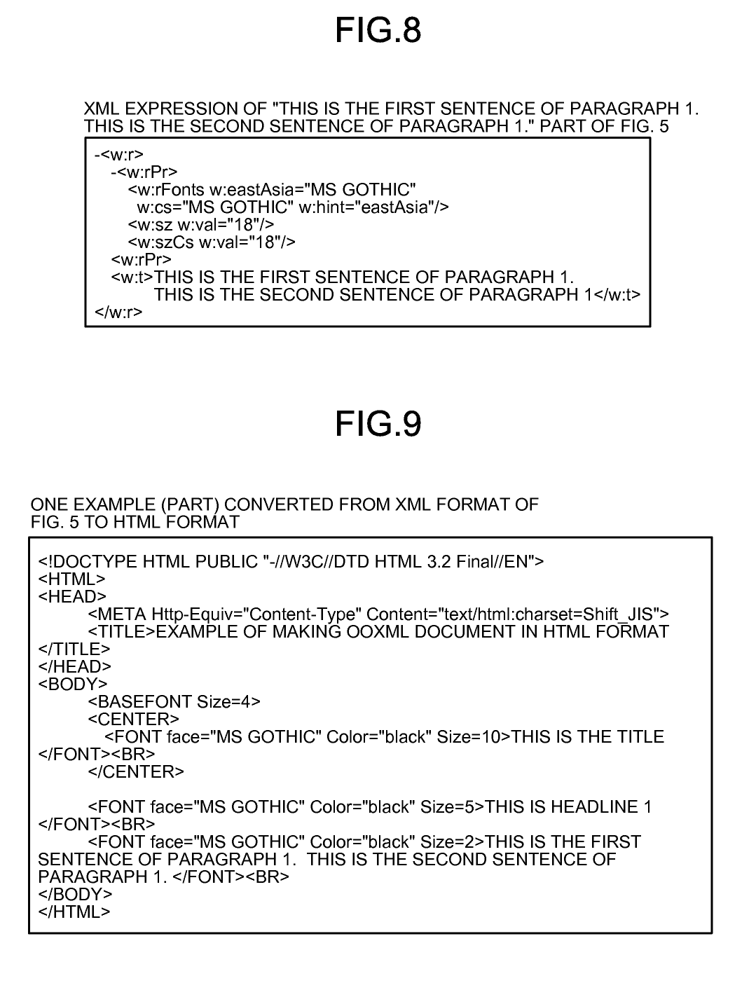

FIG. 5 is a diagram illustrating an example of a document for explaining a format of the OOXML document, and FIGS. 6 to 8 are diagrams illustrating the XML expression of the document of FIG. 5.

As described above, the XML expression is a text format and can be interpreted without using a special tool. Thus, in FIGS. 6 to 8, a font type to be used, the size of the font, and text to be displayed are defined for each paragraph in the OOXML document of FIG. 5. That is, FIG. 6 illustrates the XML expression of the “This is the title” part of FIG. 5, FIG. 7 illustrates the XML expression of the “1. This is headline 1” part of FIG. 5, and FIG. 8 illustrates the XML expression of the “This is the first sentence of paragraph 1. This is the second sentence of paragraph 1,” part of FIG. 5.

A material display application of a lecture corresponding to the OOXML document is well-known. By using such well-known material display application, it is possible to implement imaging according to the definition of the XML format. As such application, PowerPoint (registered trademark) 2007 of Microsoft (registered trademark) Corporation has been known.

Furthermore, FIG. 9 is a diagram illustrating an example in which full text of the document of FIG. 5 is converted from the XML expressions of FIGS. 6 to 8 into the HTML expression. Similarly to the XML expression, also even in an expression based on the HTML format, a font type, the size of the font, and text to be displayed are defined for each paragraph.

Thus, it can be said that conversion from the XML expression to the HTML expression is possible. Exact definition for completely allowing views after imaging to coincide with each other is necessary, and similar display is not easy but is possible to the extent that no problems occur in the understanding of information.

For conversion from the OOXML document to an HTML document, a translator is under development by Microsoft (registered trademark) Corporation. Using MS-Office, which is a product of Microsoft (registered trademark) Corporation, it is possible to read the OOXML document in the OOXML format, store the read document in the HTML format, and convert the read document into the HTML format.

Furthermore, original data used in the material of the lecture is used as is, so that a diagram is displayed with resolution equivalent to that of original lecture material even when the diagram is viewed through the Web.

Here, the conversion from the document with the OOXML format illustrated in FIG. 5 to the document with the HTML format will be described in detail with reference to FIGS. 6 to 9.

Tags used in the OOXML expressions of the documents of FIGS. 6 to 8 have the following meanings:

<w:rPr>: property such as color or size;

<w:p>: paragraph;

<w:r>: text block; and

<w:t>: actual text.

These tags have been independently defined in MS-Word (word-processing software of Microsoft (registered trademark) Corporation). However, since the tags are expressed in a plain text format, it is possible to freely read the tags.

Thus, the content of a text block surrounded by <w:r> and </w: r> is text surrounded by <w:t> and </w: t> and, as a display form thereof, description surrounded by <w:rPr> and </w: rPr> may be interpreted to acquire the size or property of a character.

In the conversion from the XML to the HTML, the character property acquired described above is uniquely converted to a format in the HTML. A conversion rule can be arbitrarily defined if no contradiction exists in the rule, and is determined by a creator of a converter.

The examples of FIGS. 5 to 8 have the following conversion rule:

font: MS Gothic→MS Gothic; and

size: 52→10.

Thus, the text <w:t> this is the title</w:t> is converted into the HTML as follows.

```
    <CENTER>
        <FONT face=“MS Gothic”Color=“black”Size=10>this
is the title</FONT><BR>
    </CENTER>
```

As described above, a part (<w:rPr>, <w:P>, <w:r>, and <w:t>) of the tag defined in the OOXML document can be interpreted and converted into the HTML document. Tag information defined in the OOXML document has been published, and a converter to the HTML document can be created by interpreting the meaning thereof.

Furthermore, even when the OOXML document is not used but a document with a format dedicated for application is used, if it is possible to read and interpret the content of the material of the lecture, the document can be converted into the HTML format. The MS-Office products, that is, Microsoft (registered trademark) Word, Excel, and PowerPoint (registered trademark), have a function of reading the document with a format dedicated for application and storing the document in the HTML format.

Furthermore, Microsoft (registered trademark) Word, Excel, and PowerPoint (registered trademark) have a function called Object Linking and Embedding (OLE) control, and it is possible to perform an automatic operation of an application by using such function. Using the OLE control, it is possible to perform a process for activating a native application, opening a document file, and storing the document file in the HTML format in a batch manner.

Moreover, an “automation” function regarding MS-Office as program part called a “Component Object Model (COM) object” has been developed. Using this function, it is also possible to perform a process for activating the native application, opening a document file, and storing the document file in the HTML format in a batch manner.

As described above, if a document is the OOXML document, the document can be automatically converted into the HTML format without a dedicated application. However, as described above, also even a document with a format dedicated for application other than OOXML can be automatically converted into the HTML document.

In recent years, since word-processing software capable of storing a document in XML format, which is standard technique, has seen an increase, more flexible data conversion is possible. In the case of the XML format, it is possible to convert all logical structures of data into a desired format using extensible Style Language Transformations (XSLT), which is standard conversion technique. In this conversion, since standardization related to views after imaging has not been made, unification is difficult. However, in the case of a document for information transmission of characters and the like, it is sufficiently useful even in a document after the conversion.

### First Embodiment

The display device having a Web server and the processing and conversion function according to a first embodiment will be described. As the first embodiment, a basic configuration of the device and data processing will be described.

The display device according to the first embodiment includes the Web server which will be described in detail later. First, a system in which the display device and an information processing apparatus using the Web server are connected to each other through a network will be first described.

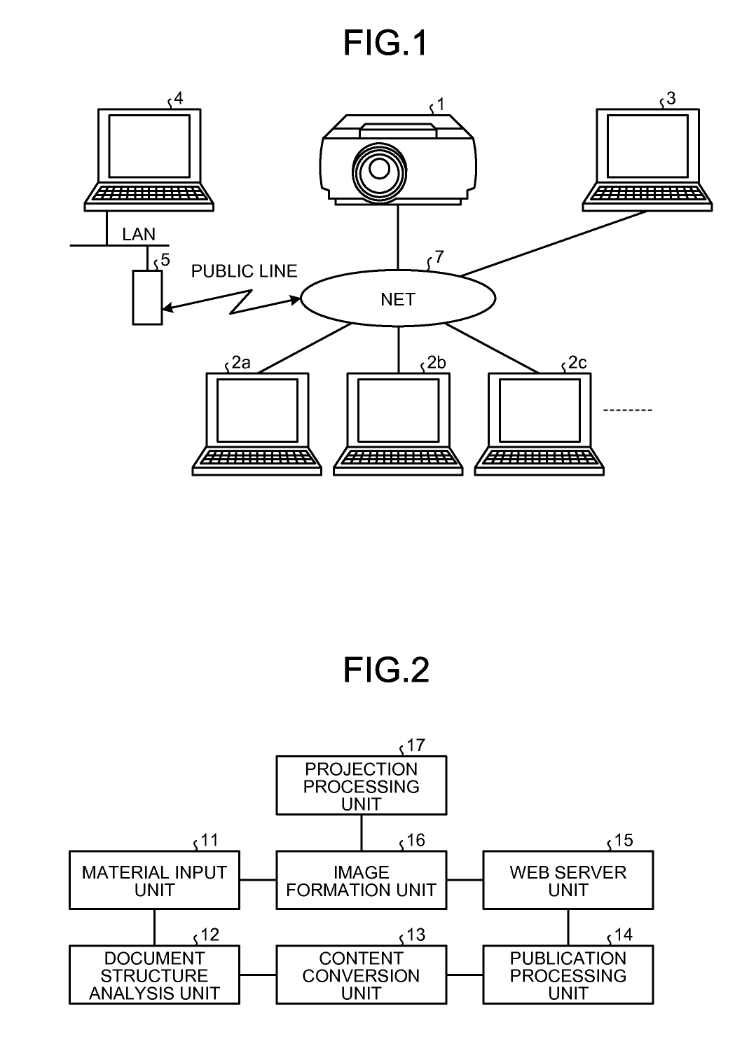

FIG. 1 is a diagram illustrating a configuration example of a system including a display device and an information processing apparatus. In this example, it is assumed that the system is utilized under the situation in which a lecturer uses a projector as a display device in a lecture meeting and displays materials on a screen toward audience, and the audience has an information terminal as an information processing apparatus.

In FIG. 1, the system includes a projector 1 as a display device, an information terminal 3 used by a lecturer, and information terminals 2a, 2b, 2c, . . . used by an audiences, which are connected to a common network 7. For a connection to an information terminal 4 used by an audience in a remote place, the network 7 is connected to a route control apparatus (a router) 5 provided in a LAN to which the information terminal 4 is connected, through a public line.

The lecturer inputs lecture materials to the projector 1 using the information terminal 3, or alternatively, if a document with a data format already made is stored in a recording medium, the lecturer directly inputs the lecture material to the projector 1 from the recording medium.

The projector 1 converts the input lecture material into Web content using a processing and conversion unit (which will be described in detail later) provided therein, and then publishes the Web content through a Web server. If the information terminals 2a, 2b, 2c, . . . used by the audience and the network are connected through the public line, it is also possible for the audience in the remote place to view the published Web content, i.e., the lecture material, with no time lag behind the lecture meeting using the information terminal 4 without a special device and setting.

Next, a data processing system provided in the projector 1 as a display device will be described.

FIG. 2 is a block diagram illustrating the configuration of the data processing system provided in the projector 1.

The data processing system in the projector 1 includes a material input unit 11, a document structure analysis unit 12, a content conversion unit 13, a publication processing unit 14, a Web server unit 15, an image formation unit 16, and a projection processing unit 17.

The material input unit 11 is a unit that receives the input of lecture material. The material input unit 11 reads electronic data of lecture material from various recording media, such as a Secure Digital (SD) card or a universal serial bus (USB) memory, on which the lecture material has been recorded. In consideration of the case where lecture material is transmitted from the information terminal 3 which may be a notebook personal computer (PC) connected to the projector 1, the material input unit 11 may be designed to receive the electronic data of lecture material.

The document structure analysis unit 12 analyzes the document structure of the input electronic data of lecture material document. Through this analysis, elements of the document structure are extracted as text data and an analysis result is obtained. The analysis result is classified into, for example, “large headline,” “small headline,” “body” and the like according to a font size and a font type. In addition to the text data, data including a diagram and the like is also extracted and is associated with the text data. In some lecture materials, the logical structure is clearly defined using a prescribed document template at the time of the creation of electronic data. In such a case, an analysis result is obtained using that logical structure.

The content conversion unit 13 converts analysis data obtained by analyzing the document structure of lecture material through the document structure analysis unit 12 into Web content. When data to be converted is text data, a font size or type is changed in the HTML format according to the logical structure of a document, so that the logical structure of original lecture material is expressed. In the case of a diagram, if the position of the diagram in the original lecture material has been recorded in association with the position of text data, the diagram can be defined such that the diagram is displayed in the vicinity of the text data even in the HTML format.

The publication processing unit 14 places the lecture material converted into the Web content at an appropriate position on the Web server unit 15, and indexes the position in the Web server unit 15. In addition, the publication processing unit 14 performs various types of setting for Web content publication such as a change in a file access right.

The Web server unit 15 controls communications with clients who access the data processing system through a network, that is, the browsers of the information terminals 2a, 2b, 2c, and 4, and delivers the Web content in response to a request.

The image formation unit 16 generates output image data by performing imaging of the electronic data of a document, that is, by performing a so-called rendering. In the case of imaging an original lecture material document, the image formation unit 16 performs an operation for receiving an input document from the material input unit 11, and generating data to be used for screen display in the projector based on the document. This operation is equal to that of a projector and is known as a conventional PC-less operation. In the case of imaging the Web content published by the Web server unit 15, the image formation unit 16 generates data to be used for screen display on the browser of a client.

The projection processing unit 17 generates an image using the data used for screen display, which has been created by the image formation unit 16, and projects the image on a screen.

Next, an operation of the data processing system of FIG. 2 at the time of document input will be described.

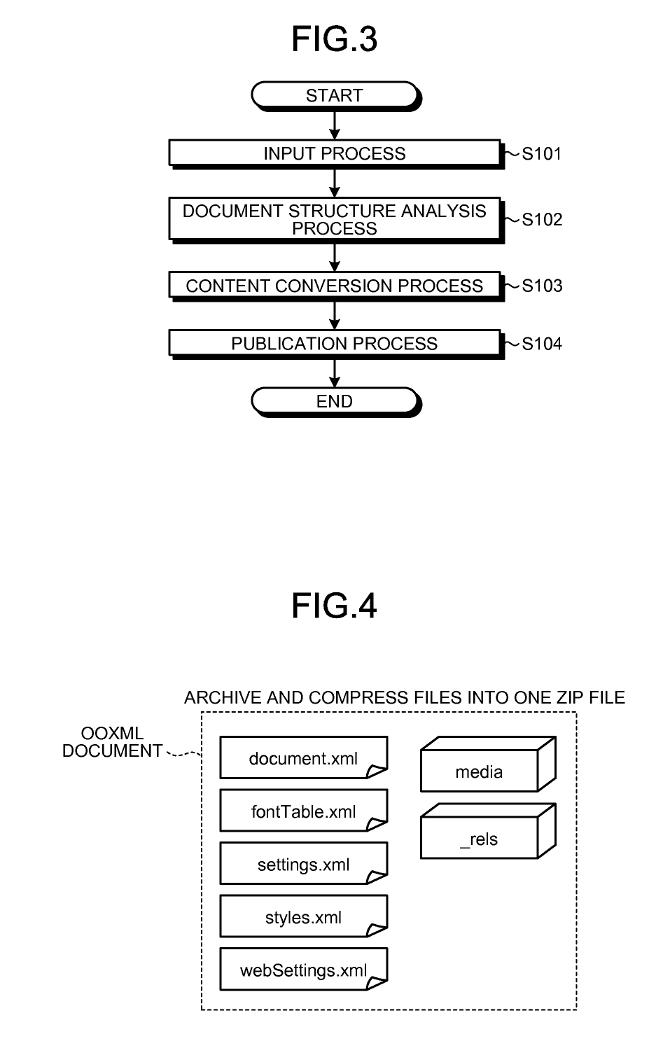

FIG. 3 is a diagram illustrating the flow of data processing from document input process to a publication process in the data processing system illustrated in FIG. 2.

In the flow of data processing of FIG. 3, when the data processing system is activated in response to a user's operation to the projector or an instruction from an information processing apparatus (for example, a PC) connected to the projector, the material input unit 11 performs an input process for receiving the input of lecture material (step S101). At this time, when the lecture material is input from a recording medium such as an SD card or a USB memory, electronic data of the instructed lecture material is loaded into a memory such as a RAM in the device in response to the user's operation for instructing the material input unit 11 to receive a target document from the recording medium. Furthermore, when a processing request is sent from the information processing apparatus (for example, a PC) connected to the projector 1, electronic data of lecture material derived through a reception process by a communication apparatus is loaded into the memory such as a RAM (Random Access Memory) in the device.

Next, the document structure analysis unit 12 analyzes the document structure of the electronic data of lecture material document input in step S101 (step S102). Through this analysis, elements of the document structure are extracted as text data, and an analysis result is obtained. The analysis result is classified as a result into, for example, “large headline,” “small headline,” “body” and the like according to a font size and a font type. In addition to the text data, data including a diagram and the like is also extracted and is associated with the text data. In some lecture materials, the logical structure is clearly defined using a prescribed document template at the time of the creation of electronic data. In such a case, a result is obtained using that logical structure.

Next, the content conversion unit 13 converts the lecture material document into Web content based on the analysis result of the document structure of lecture material analyzed in step S102 (step S103). At this time, when data to be converted is text data, a font size or type is changed in the HTML format according to the logical structure of a document, so that the logical structure of original lecture material is expressed. Furthermore, in the case of a diagram, if the position of the diagram in the original lecture material has been recorded in association with the position of text data, the diagram is defined such that the diagram is displayed in the vicinity of the text data even in the HTML format.

Next, the publication processing unit 14 places the lecture material, which has been converted into the HTML format as the Web content in step S103, at an appropriate position on the Web server unit 15, and indexes the position in the Web server unit 15 (step S104). In addition to the above processes, the publication processing unit 14 performs various types of setting for Web content publication such as a change in a file access right.

When the publication process is completed, the process flow ends.

As described above, according to the first embodiment, the electronic data of lecture material document is input to the projector 1, the data of the input document is used for screen display, and the input document is converted into a document with the HTML format as the Web content in the data processing system (FIG. 2) in the device and is placed on the Web server unit 15 in the projector 1. Therefore, it is possible to distribute fine lecture material to an audience without causing a load to a lecturer. Consequently, the audience refers to the distributed material, thereby acquiring desired information and deeply understanding lecture content.

Furthermore, the lecture material document is converted into the Web content, so that a data amount is significantly reduced as compared with the case where the lecture material is published as an image. Thus, when an image for display is used for delivery, it is also possible to avoid the problem that details of material are not seen due to a reduction of resolution by a process performed in the delivery.

In the embodiment described above, the projector provided with a projection unit has been described as an example of the display device. However, the projector is for illustrative purposes only, and the display device is not limited to the projector. For example, the present invention can be applied to general display devices called a display. That is, the present invention can be applied throughout a task of delivering information using a display device including a monitor such as a large CRT or liquid crystal having no projection unit, resulting in the achievement of the same effect.

In addition, an information transmission side and an information reception side need not be at the same place, and even when an information delivering person and audience, including one-to-one, share display content at different places using a display device, including the use of plural display devices, the same effect is achieved.

### Second Embodiment

In a second embodiment, the display device of the first embodiment capable of distributing the Web content has a function for establishing bi-directional communication between an information provider and an information acquirer. That is, based on the utilization example of the projector 1 applied to a lecture in the first embodiment, a function for establishing bi-directional communication between a lecturer and unspecified audience members capable of receiving distributed Web content is added, resulting in the function expansion.

If the lecturer understands the reaction of audience members during a lecture and makes a lecture of content corresponding to a result thereof, it is possible to improve the satisfaction of the audience. However, since the audience providing the lecturer with questions or desires during the lecture would interrupt the lecture, most audience members hesitate to tell the lecturer of their own intention, so that it becomes difficult for the lecturer to understand the reaction of the audience. In the second embodiment, the following function is added in order to solve such a problem.

When lecture material is published as Web content, audience members can not only view the lecture material using information terminals at hand, but can also transmit data to a Web server.

In this regard, when the lecture material is converted into the Web content, an input reception unit similar to a questionnaire form is provided in order to receive the reaction from the audience. The input reception unit is additionally inserted into the Web content.

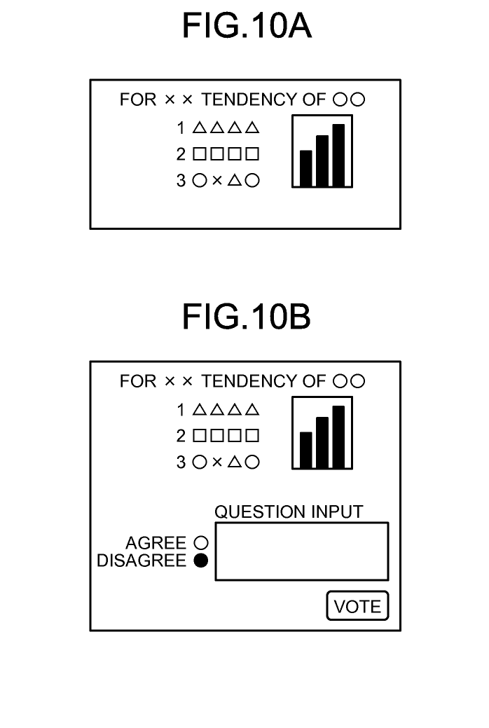

FIGS. 10A and 10B are diagrams explaining a questionnaire form additionally insertable into Web content.

FIG. 10A illustrates a display screen when lecture material has been projected on the projector 1, and FIG. 10B illustrates Web content when a questionnaire form has been additionally inserted into the lecture material. That is, as illustrated in FIG. 10B, the questionnaire form is additionally inserted into the lecture material corresponding to the display screen projected on the projector 1 when a conversion to the Web content is performed, such that radio buttons of “agree” and “disagree,” a question input form, and a vote button are provided.

Audience members respond to the questionnaire form using information terminals at hand, thereby indicating their intention of agreement or disagreement and raising questions. Consequently, it is possible for the audience to indicate their intention without interrupting the lecture.

The questionnaire form can be additionally inserted at an appropriate position based on the logical configuration of the lecture material already obtained as the analysis result in the content conversion unit 13 in the data processing system illustrated in FIG. 2.

Simply, it may be possible to use a method for inserting the questionnaire form into each page of the lecture material. At this time, in the result obtained by analyzing the logical configuration of the lecture material, it may be possible to more easily achieve the additional insertion of the questionnaire form by inserting a fixed HTML expression for defining the questionnaire form into each cut line of a page. Furthermore, as a more flexible countermeasure, it may also be possible to use a method of preparing a plurality of types of questionnaire forms and selecting an appropriate questionnaire form according to the analysis result of the lecture material.

As described above, the lecture material, into which the questionnaire form has been additionally inserted by the Web server provided in the projector 1 connected to the network, is published, resulting in the achievement of a function for establishing bi-directional communication.

Audience members access the Web server using browsers of PC terminals, cell phones and the like, and transmit opinions, questions and the like to the projector 1 of a distributor under the management of a lecturer as responses to the questionnaire form inserted at an appropriate position in the lecture material whose logical structure is analyzed.

With such a function, it is possible to immediately collect the reaction of the audience members at the time of a lecture without requiring the advance preparation of the lecturer.

### Third Embodiment

In the above-described second embodiment, when the display device capable of distributing the Web content is used in a lecture, a function for establishing bi-directional communication between a lecturer and unspecified audience members is added. In a third embodiment, a procedure of a communication connection required before using the above-described function is simplified.

In the case of communicating with a lecturer, or acquiring lecture material published on the Web, it is necessary for an audience member to connect to an information terminal of the lecturer or the Web server using an information terminal of the audience member. It is possible for the lecturer to use the following method for transmitting an e-mail address or the URL of the Web server to the audience:

1. Advance notification in writing;

2. Advance transmission by e-mail;

3. Oral communication; and

4. Projection on projector.

However, it is difficult to transmit the URL in advance to unspecified audience members. Further, if the URL is not decided until the same day, the methods 1 and 2 (advance notification and advance transmission) are not actually possible.

Furthermore, in a conference room, in relation to the method 3 for orally communicating the URL or the method 4 for projecting the URL on the projector, the audience needs to manually input the URL on their information terminals, which is inconvenient, and time is required, resulting in a reduction of valuable lecture time.

In this regard, in order to solve the above-described problem and simply distribute electronic data to unspecified audience members in a conference room without advance preparation, the third embodiment employs a technique using the following two-dimensional barcode.

A quick response (QR) code has been well-known as a two-dimensional barcode. The QR code has been widely used because of features such as reading speed and accuracy, high operability and the like. Most cell phones with a camera sold in Japan have a QR code reading function. An image of the QR code is simply photographed, so that it is possible to restore electronic data from the image.

In this regard, in the projector of the third embodiment, electronic data to be distributed to audience members is converted into the two-dimensional barcode such as the QR code and projected on a screen, and the audience photographs the two-dimensional barcode image using cell phones with a camera or the like to restore the electronic data from the two-dimensional barcode image.

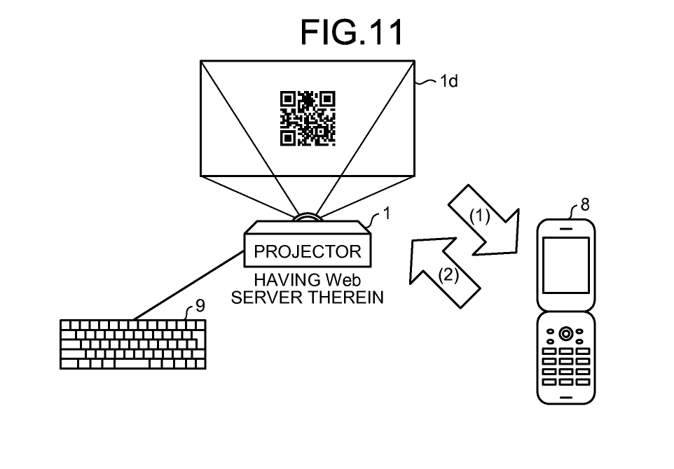

FIG. 11 is a block diagram illustrating the configuration of a system including a display device of the third embodiment and an information terminal, which use a two-dimensional barcode, and additionally illustrates a diagram explaining a communication method using the two-dimensional barcode from the display device to the information terminal.

The system using the two-dimensional barcode illustrated in FIG. 11 includes the projector 1 as the display device of the third embodiment, a screen 1d on which the projector 1 projects an image, a keyboard used for inputting a command and the like to the projector 1, an input unit 9 such as a remote controller, and an information terminal 8 with a camera possessed by audience members.

The operation of the system illustrated in FIG. 11 will be described. For example, the projector 1 converts electronic data indicating display of the URL of the Web server, which is input by a lecturer through the input unit 9 such as a keyboard, into the two-dimensional barcode, forms a display image of the two-dimensional barcode, and projects an image of the two-dimensional barcode on the screen 1d using the obtained display image.

The information terminal 8 with a camera possessed by audience member photographs the two-dimensional barcode projected on the screen 1d (as indicated by an arrow (1) in FIG. 11), and restores electronic data from the photographed image.

Next, the information terminal 8 confirms that the restored electronic data is access information to the Web server in the projector 1 and connects to the Web server using the access information (as indicated by an arrow (2) in FIG. 11).

After the connection is established, the information terminal 8 views the Web content, or inputs a response to a questionnaire form (refer to the second embodiment) provided in the Web content.

Input using the keyboard, the remote controller or the like for inputting a command to the projector 1 may be a text input or command instruction by using the keyboard, or alternatively, a command instruction through the selection of a preset menu using the remote controller or the like. Through these instruction methods, electronic data serving as a base of the two-dimensional barcode projected by the projector is input or selected.

Furthermore, the information terminal 8, for example, may be a mobile type PC as long as the PC is provided with a camera, instead of the cell phone with a camera.

As described above, according to the third embodiment, the two-dimensional barcode is projected by the projector 1. Therefore, it is possible to distribute arbitrary electronic data to the audience. If a projector has a keyboard as an input unit, it is possible to distribute arbitrary electronic data to the audience on the spot. The audience photographs the two-dimensional barcode projected on a screen using an individually used information processing apparatus (for example, a cell phone with a camera, a note PC with a camera, or the like) and restores electronic data from the barcode image, thereby receiving electronic data without manual input. Specifically, it is useful in informing the audience of the URL of the Web server or an email address, and it is possible to simply exchange information required before establishing bi-directional communication between a lecturer and unspecified audience members.

### Fourth Embodiment

In the above-described third embodiment, the URL of the Web server or the e-mail address is converted into the barcode image and is projected on the screen of the projector such that a procedure of a bi-directional communication connection to the lecturer or the Web server can be simply performed. In a fourth embodiment, specifically, adaptive conditions to the Web server that publishes lecture material are considered.

In the projector 1 described in the first embodiment, the lecture material converted into the Web content is automatically placed on the Web server. At this time, a place on the Web server is automatically generated for each lecture material. That is, according to this, the place is randomly decided for each lecture material at the input timing of the lecture material, and thus, the URL of the Web server and the email address for reception are different among the lecture materials. Thus, for example, it is possible to prevent access of other persons not knowing the URL, such as persons not in a conference room.

As described above, the URL or the e-mail address automatically generated for each lecture material is converted into the two-dimensional barcode and an image is projected on the screen. Therefore, it is possible to accurately distribute the URL and the like to audience members in a short time without causing trouble for a lecturer. Consequently, the fourth embodiment can be appropriately implemented when material of a lecture is distributed only to an audience of the lecture.

### Fifth Embodiment

A fifth embodiment in which the display device capable of distributing the Web content described in the above-described embodiments has a function for managing the Web content will be described.

In a lecture conference, generally, a plurality of lecturers give lectures on respective themes, one projector is shared at this time, and many lecturers use a projector belonging to a party who invited the lecturers to lecture.

Thus, it is difficult for the lecturers to know the management state of the projector. When lecture material has been accumulated in the projector, it is difficult to limit a distribution destination of the lecture material. Particularly, when the Web server is provided in the projector and the lecture material converted into the Web content is accumulated in the Web server as in the above-described embodiments, the distribution of the lecture material is desired to be limited after a lecture time is ended, but lecturers inexperienced in dealing with the projector may not operate the projector.

In this regard, in order to solve the above-described problem, a method is employed in which when replacement of lecture material is detected, Web content related to a previous lecture, which has been placed on the Web server, is erased.

As a unit for performing a process according to that method, in the fifth embodiment, a detection unit for detecting input of a replacement document as lecture material is provided in the material input unit 11 in the data processing system illustrated in FIG. 2, and a control function of erasing the Web content accumulated in the Web server unit 15 is added to the publication processing unit 14 in the data processing system illustrated in FIG. 2.

When the input of a replacement document is detected by the detection unit, the publication processing unit 14 having the control function of erasing the Web content erases Web content related to a previous lecture, which has been placed on the Web server.

In addition, the detection unit manages the input of a document as lecture material, recognizes an input request of a new document through a user's operation for instructing the input of a document to be processed from a recoding medium, or through the reception of a processing request from an information processing apparatus such as a PC connected to the projector 1, and detects the input of a replacement document based on confirmation of presence of the Web content accumulated in the Web server unit 15.

### Sixth Embodiment

Similarly to the above-described fifth embodiment, a sixth embodiment will be described in which the display device capable of distributing the Web content has a function of managing data processed as previous Web content when a lecture material document is replaced, but more thorough management is performed.

In the data processing system illustrated in FIG. 2, the lecture material document input from the material input unit 11 is converted into the Web content through the document structure analysis unit 12, the content conversion unit 13, and the like.

In this process, in order to improve process efficiency and ensure a working area, a temporary file may be created. Since it is possible to estimate the content of lecture material from the temporary file, in the case where replacement of lecture material is performed, it is preferable to erase all pieces of information related to a lecture material document held in the temporary file, as well as the Web content of a previous lecture material document.

In this regard, in the sixth embodiment, all pieces of information including the Web content and information held in the temporary file related to previously processed lecture material is automatically erased, so that the above-described problem is solved more thoroughly.

For the information held in the temporary file, areas where the temporary file is created are limited in advance, and are simultaneously erased when the input of a replacement lecture material document is detected, so that the information can be easily erased. As another method, a method of adding a feature indicating the temporary file to a file and erasing the file based on the feature may be used. In addition, since the temporary file is managed by a controller for controlling the entire data processing system illustrated in FIG. 2, an operation for erasing the temporary file corresponds to erasure of data in a corresponding memory area by the controller.

The input of the replacement document can be detected using the same unit as in the fifth embodiment.

### Seventh Embodiment

A seventh embodiment is identical to the fifth and sixth embodiments described above in that management is performed to erase the Web content of a document as material used in a lecture after the Web content is used. However, the seventh embodiment is different from the fifth and sixth embodiments in that power off of the projector as the display device is set as a condition for erasing the Web content.

If the Web content of the document is erased at the replacement timing of the lecture material document as in the fifth and sixth embodiments, the Web content is actually published only in a lecture time and cannot be viewed when a next lecture starts. In this operation, while the Web content of the lecture material document can be managed in a predetermined form, it is not possible to refer to already lectured content and receive the reaction from the audience after a lecture time has ended.

In this regard, the power off of the projector is set as a condition for erasing the Web content of the lecture material document. Since the Web content of the lecture material document is erased when the projector is powered off, that is, the Web content is erased when there is no audience in a conference room, the audience encounters no problem and it is possible to prevent unexpected leak of lecture material.

When the controller performs shutdown in response to the detection of the power-off event, the Web content is erased by using the same method as in the fifth embodiment.

Alternatively, instead of erasing the Web content by the above-mentioned control operation, the Web content may be recorded in a volatile storage area and erased under a normal operation in which data is erased when powered off.

### Eighth Embodiment

An eighth embodiment will be described in which the projector as the display device capable of distributing the Web content has a function of managing the Web content by erasing the Web content at the time of power off of the projector, similarly to the seventh embodiment, but more thorough management is performed.

In the data processing system illustrated in FIG. 2, the lecture material document input from the material input unit 11 is converted into the Web content through the document structure analysis unit 12, the content conversion unit 13, and the like.

In this process, a temporary file may be created in order to improve process efficiency and ensure a working area. Since it is possible to estimate the content of lecture material from the temporary file, in the case where the Web content is erased, it is preferable to erase all pieces of information related to the lecture material document held in the temporary file, as well as the Web content of the lecture material document accumulated in the Web server.

In this regard, in the eighth embodiment, all pieces of information including the Web content of the lecture material document accumulated in the Web server and the information held in the temporary file is automatically erased when the projector is powered off, so that the above problem is solved more thoroughly.

For the information held in the temporary file, since a volatile storage area is normally used, data is erased when powered off.

Furthermore, for the Web content accumulated in the Web server, when the controller performs shutdown in response to the detection of the power-off event, the Web content is erased by using the same method as in the fifth embodiment. Alternatively, instead of erasing the Web content by the above-mentioned control operation, the Web content may be recorded in a volatile storage area and erased under a normal operation in which data is erased when powered off.

### Ninth Embodiment

An embodiment in which a controller also serving as the data processing system (FIG. 2) is constructed by a computer will be described.

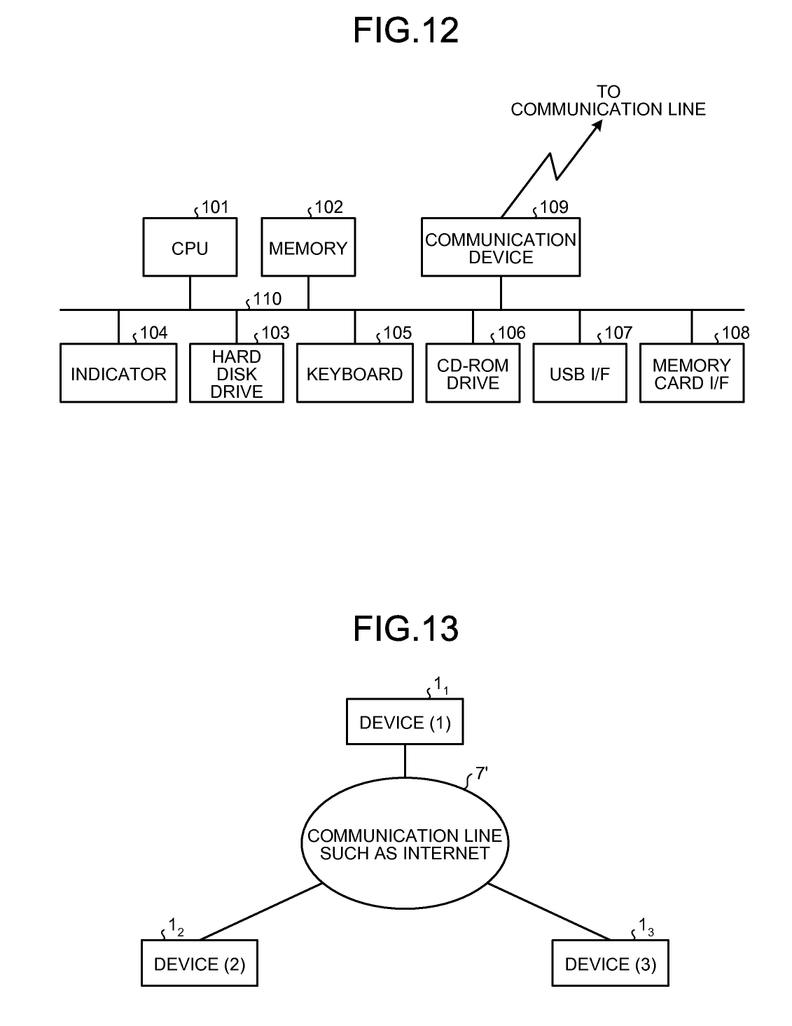

FIG. 12 is a block diagram illustrating a hardware configuration of a computer provided with a display device of a ninth embodiment.

As illustrated in FIG. 12, the computer provided with the display device of the ninth embodiment has a hardware configuration in which a central processing unit (CPU) 101, a memory 102, a hard disk drive 103, an indicator 104, a keyboard 105, a compact disc read only memory (CD-ROM) drive 106, a USB I/F 107, a memory card I/F 108, and a communication device 109 are connected to one another through a bus 110.

The CPU 101 is an arithmetic unit and controls the entire operation of the projector 1 of the ninth embodiment, as a controller. The memory 102 is a volatile storage medium capable of reading and writing information at a high speed, and is used as a working area when the CPU 101 processes information.

The hard disk drive 103 is a nonvolatile storage medium capable of reading and writing information, and stores therein an operating system (OS), various types of control programs, application programs, and information of operation parameters of the application programs.

The indicator 104 and the keyboard 105 serve as a user interface. Information used for checking the state of the projector 1 by a user is displayed on the screen of the indicator 104, and a user inputs information to the projector 1 by operating the keyboard 105.

The CD-ROM drive 106 is a storage medium capable of accumulating information with high capacity. In the ninth embodiment, the CD-ROM is available as the Web server.

The USB I/F 107 and the memory card I/F 108 are I/Fs for using various removable storage media. In the ninth embodiment, the input of the lecture material document is received through the USB I/F 107 and the memory card I/F 108.

The communication device 109 is connected to the network and used to exchange information with external information terminals. In the ninth embodiment, the communication device 109 is a unit necessary for constructing the system illustrated in FIG. 1 including the projector 1 and the information terminals 2a, 2b, 2c, 3 and 4.

In the case where the controller serving as the data processing system (FIG. 2) is constructed by the computer having the above-mentioned hardware configuration, a program for causing the computer to serve as the data processing system is recorded and loaded on the hard disk drive 103 and is driven by the computer, so that it is possible to construct a desired data processing system.

Meanwhile, a medium in which the program for constructing the data processing system is recorded is not limited to the hard disk drive 103. For example, it is possible to use the CD-ROM drive 106 or various storage media including a semiconductor ROM and a magnet optical disk (MO) (not shown).

Furthermore, as described above, since the computer of the ninth embodiment has a unit that connects the computer to the network, it is possible to use external devices connected to the network.

FIG. 13 is a diagram illustrating a configuration example of a display device constructed using a network.

A system illustrated in FIG. 13 has a configuration in which display devices 1₁, 1₂, and 1₃ each provided with a computer constructing a controller serving as the data processing system (FIG. 2) are connected to one another through a communication line 7′ such as the Internet.

As such, the display devices are connected to one another through the network. Therefore, the entrustment of processes or data transfer is possible among the display devices 1₁, 1₂, and 1₃, thereby improving the function of each apparatus.

### Tenth Embodiment

In a tenth embodiment, the Web server is provided on a network to which the projector 1 as the display device of the first embodiment is connected, instead of being provided in the projector 1.

A portable device such as a projector may encounter a fault caused by an unexpected accident such as a collision due to falling or power off due to power code unplug. Furthermore, danger such as robbery or loss is not ignorable.

In the projector 1 of the first embodiment in which the above-described problems may occur, the lecture material or the Web content may be lost or leaked due to such problems.

In this regard, in order to avoid such a situation, the ninth embodiment has a configuration in which an accumulation unit of data related to lecture content is not provided in the display device.

In order to achieve the configuration, the Web server provided in the display device of the first embodiment is separated and provided on the network to which the display device is connected.

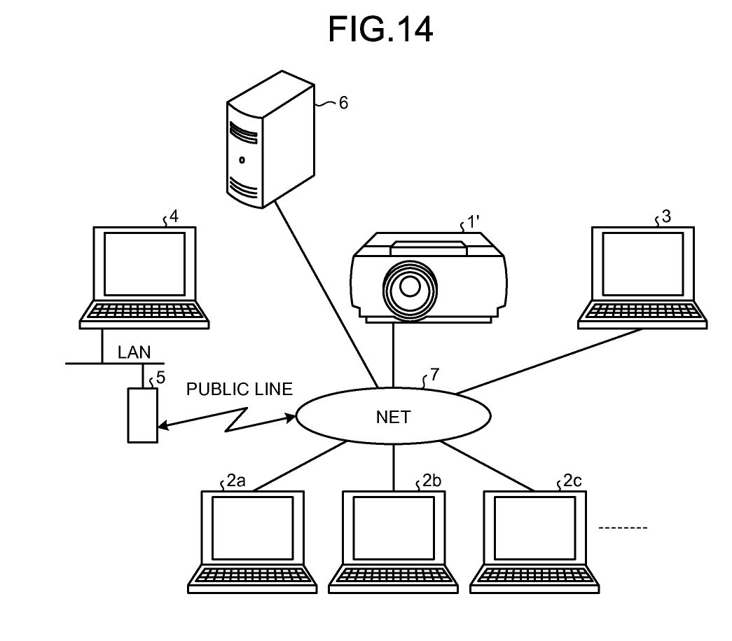

FIG. 14 is a diagram illustrating a display system having a configuration in which a display device and a server for accumulating Web content are separated from each other.

In the configuration of the system of FIG. 14, a server 6 not provided as a system element in the first embodiment (FIG. 1) is added as illustrated in FIG. 14.

Furthermore, a projector 1′ as a display device is connected to the well-known server 6 as a connection partner through the network 7. The server 6 communicates only with the projector 1′ based on an instruction related to data accumulation and management.

Meanwhile, the projector 1′ is connected to the information terminals 2a, 2b, 2c, and 4 used by many unspecified audience members, and has a function of receiving and displaying data input from the information terminals 2a, 2b, 2c, and 4.

Similarly to the data processing system (FIG. 2) of the first embodiment, the projector 1′ includes a material input unit, a document structure analysis unit for analyzing a lecture material document, a content conversion unit for performing conversion to Web content based on a processing result of the document structure analysis unit, a Web server unit for publishing the Web content, an image formation unit for imaging the lecture material document, and a projection processing unit for generating a projection image from imaged data.

The projector 1′ transmits the Web content converted in the data processing system to the server 6 through the network.

The server 6 includes a Web content accumulation unit and a publication processing unit for placing the Web content on a Web server for publication.

As described above, since the server 6 that accumulates the Web content converted from the lecture material document is connected to the projector 1′ through the network, and the server 6 is provided separately from the projector 1′, even when an error has occurred in the projector 1′, it is possible to protect the Web content without having influence on the Web content.

Furthermore, in the system of FIG. 14, data such as a distribution request received from many unspecified audience members is not transmitted to the server 6. Incorrect data or instructions can be blocked by the projector 1′.

Furthermore, since it is necessary for the server 6 to provide an instantaneous service to a display device such as a predetermined projector as a client, security is strictly operated in order to stably perform continuous operation.

Meanwhile, since it is necessary for the projector 1′ to receive the input of a lecture material document from a lecturer arriving on site for the first time that day and to publish Web content to many unspecified audience members in a conference room, forcing strict security setting is also expected to obstruct connection work, and a lecture may not be smoothly performed.

Thus, the projector 1′ provides only various functions, and content information is provided to many unspecified audience members from the server 6 through the projector 1′. Since only the well-known projector 1′ can be connected to the server unit, only an operation related to transmission/reception of Web content is performed between the server 6 and the projector 1′, so that it is possible to prevent the server unit from being connected to many unspecified persons and an incorrect operation from being performed.

Since the server 6 and the projector 1′ are separated from each other as hardware, and operations permitted in the server 6 and the projector 1′ are limited, even when the information terminal 3 used by a lecturer is connected to the projector 1′ so that the operation of the projector 1′ is permitted, influence is limited only to the projector 1′ and does not affect the server 6. Therefore, it is possible to prevent problems related to security such as an erroneous operation or an intentional change.

Furthermore, the server 6 may provide predetermined display devices such as a plurality of projectors with a data accumulation and management function of Web content. With such a configuration, it is also possible to easily perform a management task such as display of the same content on the plurality of display devices or simultaneous update of firmware and the like of the plurality of display devices.

In addition, since the server 6 can know the use states of a predetermined display device such as a projector, charging or fault management inspection according to the use state of the display device can also be easily performed. Consequently, a system in which the server 6 and the display devices are separated from each other on the network is appropriate for development of a service providing business.

According to the embodiments described above, it is possible to reduce a processing load of a Web server and a Web client in a display device or a display system having a function capable of publishing an input document through the Web server.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device that is capable of connecting to an information processing apparatus through a network, generates data for display based on electronic data of a document, and performs image display using the generated data for display, the display device comprising:
a Web server unit that publishes Web content;
a document structure analysis unit that analyzes a logical structure of the document and extracts elements of the logical structure;
a data conversion unit that converts data of each of the elements extracted as an analysis result by the document structure analysis unit into Web content; and
a publication processing unit that places the Web content converted by the data conversion unit on the Web server unit.

2. The display device according to claim 1, comprising:
a questionnaire form insertion unit that, when a predetermined element is extracted as the analysis result by the document structure analysis unit, inserts a questionnaire form into Web content of the predetermined element.

3. The display device according to claim 1, comprising:
a command input unit;
a barcode generation unit that converts electronic data that is input with a command input through the command input unit into a barcode;
a display data generation unit that generates display data used in screen display of the barcode generated by the barcode generation unit; and
an image formation unit that performs image display of the barcode using the display data generated by the display data generation unit.

4. The display device according to claim 3, wherein the electronic data that is input with the command input to the barcode generation unit includes data indicating access information to the Web server unit.

5. The display device according to claim 1, comprising:
a detection unit that detects input of a replacement document; and
a control unit that, when the input of the replacement document is detected by the detection unit, causes the publication processing unit to erase Web content related to a replaced document placed on the Web server unit.

6. The display device according to claim 1, comprising:
a detection unit that detects input of a replacement document; and
a control unit that, when the input of the replacement document is detected by the detection unit, erases all pieces of data related to a replaced document.

7. The display device according to claim 1, comprising:
a control unit that causes the publication processing unit to erase Web content in the Web server unit in conjunction with power-off event of the display device.

8. The display device according to claim 1, comprising:
a control unit that erases all pieces of data related to the document in conjunction with power-off event of the display device.

9. A computer program product comprising a non-transitory computer-readable medium including computer-readable program codes embodied in the medium, the program codes, when executed by a computer, causing the computer to serve as the Web server unit, the document structure analysis unit, the data conversion processing unit, and the publication processing unit included in the display device according to claim 1.

10. A display system comprising:
a display device that generates data for display based on electronic data of a document and performs image display using the generated data for display; and
a server that is connected to the display device through a network, wherein
the display device includes:
a Web server unit that publishes Web content;
a document structure analysis unit that analyzes a logical structure of the document and extracts elements of the logical structure; and
a data conversion unit that converts data of each of the elements extracted as an analysis result by the document structure analysis unit into Web content, and
the server includes:
a Web content accumulation unit that accumulates the Web content converted by the data conversion unit and transmitted from the display device through the network; and
a publication processing unit that places the Web content on the Web server unit of the display device.
